(19) United States
(12) Patent Application Publication
(10) Pub. No.: US 2022/0239676 A1
(43) Pub. Date: Jul. 28, 2022

(54) CYBER-SAFETY THREAT DETECTION SYSTEM

(71) Applicant: CloudCover IP, LLC, Burnsville, MN (US)

(72) Inventors: Robert James Demopoulos, Burnsville, MN (US); Stephen Cardot, Burnsville, MN (US)

(21) Appl. No.: 17/587,129

(22) Filed: Jan. 28, 2022

Related U.S. Application Data
(60) Provisional application No. 63/142,866, filed on Jan. 28, 2021.

(51) Int. Cl. H04L 9/40

(52) U.S. Cl. CPC H04L 63/1416; H04L 63/20

(57) ABSTRACT

A cyber-safety threat detection system for proactively detecting an intrusion attempt of a computing device. The cyber-safety threat detection system is provided on an application specific integrated circuit (“ASIC”) chipset or a system on a chip (“SOC”).

### REFERENCE TO RELATED APPLICATION

This application claims priority to Provisional Applic. No. 63/142,866, filed on Jan. 29, 2021, the contents of which are incorporated herein by reference.

### TECHNICAL FIELD

This application relates generally to monitoring data traffic related to computing systems, and more particularly to an integrated system for monitoring data traffic.

### BACKGROUND

Security is now a very important aspect of any computing system connected to the Internet. To provide protection from different types of security threats, a typical computing system may employ a significant number of technologies to monitor the computing system and, in some cases, perform actions to protect the computing system from identified threats or potential threats. These technologies are referred to as functions.

Administrators have a further challenge in that most attacks occur quickly. Often, by the time the administrator has determined from the data provided by the various monitoring functions that a concerted attack on multiple fronts is occurring, it has either succeeded or failed. Administrators cannot analyze the data provided in time necessary to provide effective feedback to the various monitoring functions.

In reality, even though a plethora of threat data exists and is being reported in real time, it is typically used after the fact to determine what occurred after a successful attack.

### SUMMARY

The invention includes any application specific integrated circuit (“ASIC”) chipset that monitors and analyzes communications received from an external communication network. The ASIC may be of any type known in the art (SOAC, ASISP, etc.) for implementation on one or more computing systems that handle incoming and outgoing communications between the external communications network and a protected computing network (the “protected network”) having at least one computing device.

The ASIC chipset receives communications from the communications network, such as the Internet, a telephone system, a wireless network, or any combination of communications networks, screens the communications for threats, and transmits safe communications to the appropriate destination within the protected network it serves while deleting communications that represent potential threats to the protected system.

The ASIC chipset screens a plurality of different types of communications, such as e-mail messages, VPN communications, web page traffic, and any other service (RFC or other known service). (RFC means Request for Comments from Internet Engineering Task Force (“IETF”), the principal technical development and standards-setting bodies for the Internet and acts much like a standard.) New rules are automatically developed and implemented by the chipset.

In accordance with other aspects, the invention relates to a method of automatically generating rules for protecting a protected computing network. The method includes analyzing a data packet received from a communication network by the chipset using a predetermined set of rules. The data packet includes information identifying the packet's source (e.g., a source IP address) and the packet's destination. In response to the packet failing the analyzing operation, the chipset searches an event database for events associated with the source of the packet. If the event database contains an event record associated with the source of the packet, a new rule is generated to block subsequent packets from the source of the packet for a predetermined period of time. The new rule is then added to the set of rules used by the chipset.

An embodiment of the invention is directed to a cyber-safety threat detection system for proactively detecting an intrusion attempt of a computing device. The computing device is configured to receive communication data packets from an external communication network. When moving from the external communication network to the computing device, the communication data packets pass through the cyber-safety threat detection system. The cyber-safety threat detection system is provided on an application specific integrated circuit (“ASIC”) chipset or a system on a chip (“SOC”). The cyber-safety threat detection system includes a threat event database, a plurality of cyber-safety threat monitors and a security system integrator. Each threat monitor is in communication with the threat event database. Each threat monitor analyzes the communication data packets from the external communication network and identifies the communication packets that pose a security threat to the computing device by applying a plurality of security rules. Each threat monitor generates a threat event data for each of the communication packets that were found to pose the security threat to the computing device. Each threat monitor transmits the threat event data for the security threat to the threat event database. The security system integrator is configured to analyze the threat event data and the plurality of threat event records and, based on the results of the analysis, automatically generate at least one new security rule and add the at least one new security rule to the plurality of security rules before a subsequent communication data packet is analyzed by the plurality of monitors.

Another embodiment of the invention is directed to a cyber-safety threat detection method for proactively detecting an intrusion attempt of a computing device. Communication data packets are transmitted from an external communication network to a computing device. When moving from the external communication network to the computing device, the communication data packets pass through a cyber-safety threat detection system provided on an application specific integrated circuit (“ASIC”) chipset or a system on a chip (“SOC”). The cyber-safety threat detection system includes a threat event database, a plurality of cyber-safety threat monitors and a security system integrator. The threat monitors communicate with the threat event database, analyze the communication data packets, identify the communication packets that pose a security threat to the computing device by applying a plurality of security rules, generate a threat event data for each of the communication packets that were found to pose the security threat to the computing device and transmit the threat event data for the security threat to the threat event database. The security system integrator analyzes the threat event data and the plurality of threat event records using the security system integrator and, based on the results of the analysis, automatically generates at least one new security rule and adds the at least one new security rule to the plurality of security rules before a subsequent communication data packet is analyzed by the plurality of monitors.

Another embodiment of the invention is directed to a cyber-safety threat detection system for proactively detecting an intrusion attempt of a computing device. The computing device is configured to receive communication data packets from an external communication network. When moving from the external communication network to the computing device, the communication data packets pass through the cyber-safety threat detection system. The cyber-safety threat detection system is provided on an application specific integrated circuit (“ASIC”) chipset or a system on a chip (“SOC”) that is in the computing device. The cyber-safety threat detection system includes a threat event database, a plurality of cyber-safety threat monitors and a security system integrator. Each threat monitor is in communication with the threat event database and is configured to analyze the communication data packets from the external communication network and identify the communication packets that pose a security threat to the computing device by applying a plurality of security rules, generate a threat event data for each of the communication packets that were found to pose the security threat to the computing device, and transmit the threat event data for the security threat to the threat event database. Operation of the cyber-safety threat detection system is done without calling back to a threat event database that is external to the ASIC chipset or SOC. The security system integrator is configured to analyze the threat event data and the plurality of threat event records and, based on the results of the analysis, automatically generate at least one new security rule and add the at least one new security rule to the plurality of security rules before a subsequent communication data packet is analyzed by the plurality of monitors.

### BRIEF DESCRIPTION OF THE DRAWINGS

FIG. 1 illustrates an ASIC chipset in accordance with an embodiment of the invention.

FIG. 2 illustrates some of the functions of an embodiment of the ASIC chipset for a computing system.

FIG. 3 illustrates a detailed embodiment of the ASIC chipset.

FIG. 4 illustrates, at a high level, an embodiment of the logical operations of the application specific chipset.

FIG. 5 illustrates an embodiment of the logical operations of the application specific chipset.

FIG. 6 illustrates an embodiment of the logical operations of a firewall analysis operation of the application specific chipset.

FIG. 7 illustrates an embodiment of the logical operations of the event data analysis operation of the application specific chipset.

### DETAILED DESCRIPTION

An embodiment of the invention is directed to a cyber-safety threat detection system that is on an ASIC chipset. A significant aspect of the invention is that it can efficiently stop cyber-safety threats without respect to a particular operating system and other software on the computing device on which the ASIC chipset is associated.

Because the cyber-safety threat inspection and control functions are agnostic of the operating system and other software on the computing device, the ASIC chipset may be used in conjunction with a wide variety of operating systems and other software on the computing device. Such a configuration enables the invention to be utilized in conjunction with virtually any electronic device such as desktop computers, laptop computers, network computers, smartphones and internet of things (“JOT”) devices.

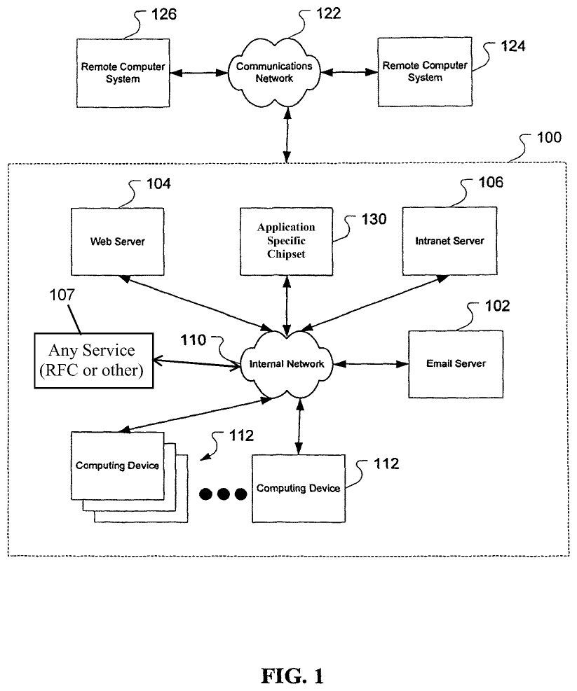

FIG. 1 illustrates an exemplary computing system 100 that implements an embodiment of the ASIC chipset 130. Implementation of the invention utilizing the ASIC chipset provides significant benefits over the invention described in U.S. Pat. Nos. 8,832,833 and 10,326,777, which are owned by a related entity to the assignee of this application. Prior art cyber-safety data traffic monitoring systems are implemented utilizing software, which is quite distinct to the implementation of the invention described and claimed herein using the ASIC chipset.

Because of this difference, this invention is able to detect cyber-safety threats much more quickly than the prior art software implemented cyber-safety data traffic monitoring systems. For example, the software implemented cyber-safety data traffic monitoring systems have response times in the range of 12-18 microseconds, the ASIC chipset implemented cyber-safety data traffic monitoring systems have response times in the range of 2-4 microseconds. The threat detection response time associated with this invention is thereby less than ⅓ of the threat detection response time of the prior art system. The sooner that a cyber-safety threat is detected, the sooner that protective measures can be implemented to stop, block or neutralize the cyber-safety threat.

Additionally, implementation of the invention utilizing the ASIC chipset is not an obvious modification of the integrated monitoring system described and claimed in preceding patents. Other entities such as Intel and McAfee have unsuccessfully attempted to implement this concept in a chipset. It is believed that a primary reason that these prior art efforts were unsuccessful is that they utilized an external database in conjunction with the chipset. In contrast, the invention described and claimed herein operates without calling back to an external database.

Another advantage of the cyber-safety data traffic monitoring system of this invention over the prior art is that the ASIC chipset is continuously and dynamically updatable. The ASIC chipset is thereby continually acquiring knowledge (learning) and algorithmic updates in real-time. In certain embodiments, the ASIC chipset is updated every 4 seconds to 15 minutes. In other embodiments, the ASIC chipset is updated every 4 to 15 seconds. While the prior art ASIC chipsets are updatable, the updates were done manually and/or on a periodic basis. Such systems are not suitable for use in cyber-safety where threats are always changing.

In one such embodiment, the ASIC chipset is provided on a network interface card (“NIC”) such that the cyber-safety data traffic monitoring is embedded in the hardware of the NIC card. Alternatively or additionally, the ASIC chipset may be implemented on an IOT device. Since IOT devices are greatly enhancing their functionality including IOT devices communicating with each other, implementing the cyber-safety data traffic monitoring system on the ASIC chipset in the IOT devices protects the IOT devices from cyber-safety threats.

In addition to implementing the invention using the ASIC chipset, it is also possible to utilize the invention in conjunction with a system on a chip (“SOC”). Implementation of the invention in conjunction with SOC would be similar to what is described herein with respect to the ASIC chipset.

The exemplary computing system 100 as shown includes an email server 102, a web server 104, an intranet server 106 and any other service (RFC or other) 107. The servers are further connected to an internal communication network 110, such as an intranet. The internal communications network 110 connects the various computing devices and components internal to the computing system 100. In the embodiment shown, the internal network 110 is connected to the servers 102, 104, 106 and a plurality of additional computing devices 112. The computing system 100 is further connected to other remote computing systems 124, 126 via an external communications network 122. The external communications network 122 may be the Internet or may be some other wired or wireless communications network.

In the environment shown in FIG. 1, communications data traffic in the form of data transmitted on the network 122 may pass between the computing system 100 and the remote computing systems 124, 126. In addition, there also may be communication data traffic passing between various elements within the computing system 100.

The communications data traffic on the network 122 and within the computing system 100 will be discussed as consisting of a plurality of separate and identifiable “messages”. Examples of messages on the Internet include, for example, digital files, email messages, web pages, voice over internet protocol (“VOIP”) data streams, and streaming audiovisual data. Messages are transmitted in digital form as one or more packets of digital data.

The embodiment in FIG. 1 also includes the ASIC chipset 130, which monitors communication data traffic. The application specific chipsets 130 may be implemented to monitor data traffic on the internal network 110, data traffic received from the external network 122, or both depending on the implementation. The ASIC chipset 130 analyzes the communication data traffic to identify messages that may pose a threat to the computing system and block or quarantine any such messages identified.

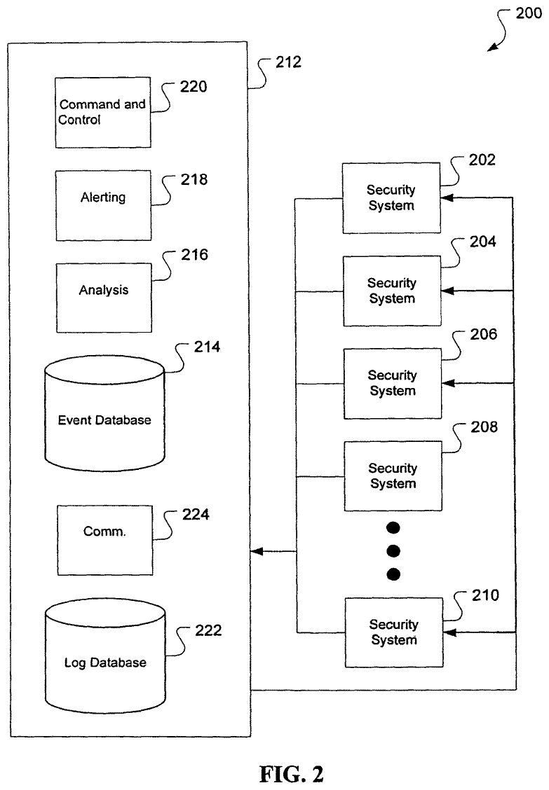

Such threats include any unwanted or undesirable occurrence related to data traffic such as, for example, spam, viruses, denial of service attacks, unauthorized attempts to infiltrate the computing system, etc. While some threats may be actual threats of harm or damage to the system, others may simply be inconvenient, annoying or unwanted events and not pose any risk of damage to the computing system. The ASIC chipset 130 will be discussed in greater detail with reference to FIG. 2 below.

FIG. 1 shows the ASIC chipset 130 connected to the internal network 110. However, it should be noted that the ASIC chipset 130 may be connected to the internal and external networks in many different ways and still perform its security functions. For example, in one embodiment the ASIC chipset 130 is implemented as a gateway between the external communication network 122 and the internal communication network 110.

Messages destined for the computing system 100 are screened by the ASIC chipset 130 before being passed on to the internal network 110. In an alternative embodiment, all messages carried on the internal network, regardless of whether they originate from a computing device 112, a server 102, 104, 106 or the external network 122, pass through the ASIC chipset 130.

FIG. 2 illustrates the functionality of an embodiment of the ASIC chipset 200 for a computing system. The ASIC chipset 200 includes multiple monitoring functionality 202, 204, 206, 208, 210, and a security system integrator (“SSI”) 212. The SSI receives data through the chipset. Functionality of the SSI 212 may include analysis 216 that analyzes the contents of an event database 214, alerting 218 that transmits security alerts (such as to system administrators and users), command and control 220 that provides functionality between the SSI 212 and the monitoring functionality 202, 204, 206, 208, 210, communication 224 that supports the reporting of the contents of the event database 214 to other locations, and a log database 222 that stores a log record of actions taken by the ASIC chipset 200 over time. Each of these components is discussed in greater detail below.

The ASIC chipset 200 includes a plurality of functions 202, 204, 206, 208, 210. Each function 202 may independently perform one or more different monitoring and security functions. The functions may overlap. In general, each function may track and evaluate communications data traffic on a communication network (internal, external or both depending on how the ASIC chipset 200 is implemented within the computing system).

Each of the functions 202, 204, 206, 208, 210 are connected to the communication network of the computing system as necessary to perform their given function. Examples of functions include connection monitoring, extracting IP information from the network, monitoring data traffic, detecting intrusion and preventing that detect and attempt to block attacks, host-based intrusion detection systems, forwarding information, and password protection.

The functions monitor the communications data traffic to identify messages that may pose a security threat to the computing system. Each monitoring function may evaluate the communication data traffic in a different way in an attempt to identify different potential threats. Upon identification of a potentially threatening message by a monitoring function, the monitoring function may take unilateral action to address the threat. In addition to any such unilateral action, the functions also report event data related to the events that are identified.

Each message identified as a potential security threat by one or more of the functions is a single “event.” That is, if a message is identified by several different functions, possibly for different reasons, as a potential threat, that message will be considered a single event, as described in greater detail below.

Each function 202, 204, 206, 208, 210 may provide data related to the communications data traffic on the network. For identified events, these functions may generate and report data describing or otherwise related to the event. This data, referred to as event data, may be the only indication that a potential threat has been identified.

The event data reported is dictated by the chipset rules. Such event data may include, for example, may be data identifying the source of the event data, the event type, a priority associated with the event determined by the chipset rules, a timestamp for the event, and one or more identifying details of the message that is the source of the event, such as the source IP address, port, URL or MAC of the message, an identifier indicating if the source is internal to the computing system, the destination IP address, port, URL or MAC of the message, an identifier indicating if the destination is internal to the computing system, and information concerning whether the message is coming from a known “bad” or “good” host. The event data may be provided as a simple ASCII file with a known format, as XML that include data type definitions, in an HTML file, or in any other form, as long it is known to and useable by the SSI.

For example, the chipset may remember the context of connections and continuously updates this state information in dynamic connection tables, may use one or more IP tables to identify known sources of threats and automatically block data traffic from those IP addresses in the IP tables. In the event that messages from IP addresses in the IP tables are identified and blocked, the chipset may report event data to the SSI including the source IP address, the destination IP address, identifying information regarding the content of the message, and the date and time the message was received.

Another function of the chipset is to include an internal set of rules for use in evaluating and blocking messages in real time. Upon detection of a threat, the chipset may report an alert, a threat ID and description, a timestamp, and the source and destination IP addresses of the message. Additional event data may also be reported depending on the implementation.

In the embodiment, the event data generated by functions 202, 204, 206, 208, 210 are stored in an event function 214. In one embodiment, the chipset maintains the event database 214 so that all event data received from the functions 202, 204, 206, 208, 210 relating to a specific event (i.e., a single message) is collected and stored within a single event record in the event database. In an alternative embodiment, a new event record is created for each item of event data received. To prevent the database from getting too big, the event database 214 may purge event data that reach a specified age or may store data until some predetermined database size is reached.

The event database may be structured in various ways. In one embodiment, a single Event Log Table is maintained. The Event Log Table is the primary repository of the event data. As described above, the event data provided by the chipset functions is stored in event records in the Event Log Table. In addition, various other data generated by the chipset functionality related to the event may also be included in an event record. For example, the chipset may generate unique identifiers for each event record to support future error detection or transmission operations. TABLE 1, below, includes a list of various event data, along with their descriptions, that may be included in a record, such as an event record, in the tables described above.

TABLE 1
EVENT DATA

| Event data type | Description |
|---|---|
| Event Priority Description | Description of the event priority, such as “CRITICAL EVENT”. |
| Log Source Description | Description of the source of the event |
| Event Type Description | The type of event, such as an attack contained in an attachment. |
| Event Description | Description of the event, such as for an attack event type the name |
| | of the attack identified. |
| Event Date and Time | A time stamp related to the event, such as when the message was |
| | received by the computing system. |
| Source IP | The IP address that the event identifies as its origination point. |
| Event Protocol | Common network communications protocol such as TCP, UDP, |
| | ICMP, etc. |
| Source Port | The IP port that a transmission originated from, e.g.: HTTP data |
| | generally originates from port 80. |
| Source URL | The uniform resource locator (“URL”) address that the event |
| | identifies as its origination point. |
| Source MAC | This is the Media Access Control address for network devices |
| | (a.k.a. nodes). This is a standard unique “ID” for each physical |
| | port of network devices such as computer network interface cards, |
| | network switching equipment, etc. The Source MAC refers to the |
| | ID of the communication packet source device. |
| Internal Source | Data indicating if the origination point of the event is internal to the |
| | computing system 200. |
| Blocked Source | Data indicating if the origination point of the event is blocked by an |
| | existing rule in the computing system 200. |
| Blocked Destination | Data identifying a destination within the protected network that is |
| | blocked by the administrator from receiving communications. |
| Destination IP | The IP address that the event identifies as its destination. |
| Destination URL | The uniform resource locator address that the event identifies as its |
| | destination. |
| Destination Port | The target IP port for a transmission, e.g.: HTTP data is generally |
| | received by port 80. |
| Destination MAC | This is the Media Access Control address for network devices |
| | (a.k.a. nodes). This is a standard unique “ID” for each physical |
| | port of network devices such as computer network interface cards, |
| | network switching equipment, etc. The Destination MAC refers to |
| | the ID of the communication packet recipient device. |
| Internal Destination | Data indicating if the destination point of the event is internal to the |
| | computing system 200. |
| Auto Bad Host | Data indicating the corresponding source has been manually |
| | entered as a bad host, and should therefore be blocked without |
| | further analysis (the “Auto” refers to how the default value of this |
| | column is set when not specified). |
| Auto Good Host | Data indicating the corresponding source has been manually |
| | entered as a good host, and should therefore be allowed without |
| | further analysis (the “Auto” refers to how the default value of this |
| | column is set when not specified). |

The analysis functionality 216 analyzes the event data to identify trends and anomalies in the event data. This analysis may use various statistical analysis techniques to determine if an event poses a greater threat than that identified by the functions reporting the event data. The analysis functionality also determines if an event potentially poses a type of threat that the other chipset functions are not designed to identify. Upon each receipt of new event data, the analysis functionality 216 reanalyzes the contents of the event database to determine if the new event data changes the results of its previous analysis.

One example of an analysis performed by the analysis functionality 216 is a Bayes' Theorem, or Bayesian, analysis. A Bayesian analysis is a statistical procedure that estimates parameters of an underlying distribution based on an observed distribution. Beginning with a prior distribution, which may be based on anything including an assessment of the relative likelihoods of parameters or the results of non-Bayesian observations, event data is collected and an observed distribution is created.

Then a calculation may be made to estimate the likelihood of the observed distribution as a function of parameter values. By multiplying this likelihood function by the prior distribution, a unit probability over all possible values is obtained. This is called the posterior distribution. The mode of the distribution is then the parameter estimate, and probability intervals (the Bayesian analog of confidence intervals) can be calculated using the standard procedure. In embodiments, the Bayesian analysis may be performed on any of the event data provided by other chipset functions, such as source IP addresses, to determine a likelihood that messages from a source IP address are threats.

Additional analyses performed by the analysis functionality 216 may be designed to identify anomalies and trends in the event records. To do this, the contents of the event database are scanned and events with common data are identified. For example, the analysis will identify event records from common chipsets or with common data source/destinations. In addition, the scanning may also seek to identify known trends indicative of known threats.

Events identified with common elements or other known issues are then weighted based on a predetermined weighting algorithm that takes into account the type, priority, monitoring function and specifics of the event. The weighting algorithm produces a sum weight for these common events indicating a base severity of the threat (i.e. a threat level). The analysis functionality 216 then identifies what actions, if any, should be performed based on the calculated threat level.

Upon completion of an analysis by the analysis functionality 216, the results of the analysis may be that the event, and possibly any future messages having specific attributes (for example a point of origination, a destination or specific text in a subject line), should be treated differently by the ASIC chipset 200 than they are currently being treated. For example, the analysis may determine that every email coming from a certain IP address is likely to be classified as an event by one or more functions and should be screened by such functions prior to entering the computing system.

In these cases, the analysis functionality 216 may issue commands to other functions of the chipset. These commands may subsequently be passed, for example by the command and control function 220 as described below, to any connected external component, monitoring function or computing system.

In general, the commands allow the SSI 212 functionality to control the operation of any of the other components and devices of the integrated monitoring functioning system 200. The commands issued by the SSI 212 functionality may be as simple as a command to add a certain IP address to one or more of its IP tables of IP addresses to block. Other examples of commands include commands to one or more functions that create a new rule to use when evaluating network data traffic, commands directing that messages with specific content be allowed to pass, be blocked or be quarantined, commands to expand the list of external systems and logs that are evaluated, commands to automatically delete future messages sent to a specified computer port for a specified period of time, and commands changing the threat level assigned to different events. Commands may be issued to the alert functionality 218 to generate alerts.

An analysis by the analysis functionality 216 may determine that a system administrator, various system users, or other designated parties should be alerted to events identified by the SSI 212 functionality. In these cases, the alert functionality 218 identifies the parties that should be alerted and generates the alert messages with the appropriate data from the event database 214.

The command and control functionality 220 acts as an interface between the various chipset functions within the SSI 212 and the monitoring functioning functions 202, 204, 206, 208, 210. The command and control function 220 stores information concerning how to interface with each monitoring function.

Using this information, the command and control functionality can receive a notification, such as from the analysis functionality 216 for example, that an action by a specific monitoring function functionality is required and generate a command for the specific monitoring function that carries out the action. Because the command and control functionality 220 allows the SSI 212 to issue commands to any of the other chipset functions capable of receiving commands, an administrator may use the SSI 212 as a central control point for the ASIC chipset 200.

The communication functionality 224 supports the communication between the various of the SSI 212 functionality and components and systems external to the SSI 212 functionality. In some embodiments, the communication functionality 224 periodically transmits any new event data received by the event database 214 to a remote computing system or external device for storage or further analysis.

A log database 222 is maintained by the SSI 212 functionality to track actions taken by the SSI 212 functionality. The log database 222 may also store log entries recording commands received by the SSI 212 functionality (such as from the administrator) and directed at one or more functions. Other activities may be logged as well depending on the preferences of the system administrator.

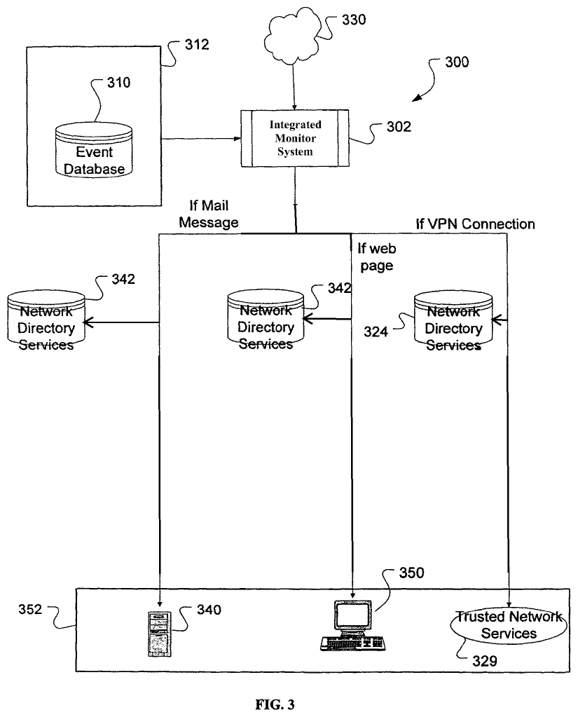

FIG. 3 illustrates a computing system 300 that includes an embodiment of an integrated monitoring system. The computing system 300 is a communications system that handles incoming and outgoing communications between an external communications network 330 and a protected computing network 352 (hereinafter the “protected network”) having at least one computing device 350.

In a protected network 352 that consists of a single computing device 350, the computer system 300 may be implemented as a software program executing on the computing device 350 or may be implemented as a separate and distinct computing device through which all incoming communications to the eternal network 330 pass.

In an embodiment in which the computing system 300 serves a protected network 352 having a plurality of computing devices 350, the computing system 300 may be implemented on one or more separate computing devices, such as a router or communication-dedicated computing device, depending on the flow rate of communication data traffic that must be handled.

The computing system 300 receives communications from a communications network 330, such as the Internet, a telephone system, a wireless network, or any combination of communications networks, and transmits the communications to the appropriate destination within the protected network 352 it serves. The destination may be a specific software program executing on a computing device 350 within the network or a software program operating on the computing system 300.

The computing system 300 shown is capable of receiving a plurality of different types of communications. The computing system 300 can receive electronic mail messages (e-mail) and pass them on to a mail server 340 that is responsible for distributing e-mail to various user mailboxes. The computing system 300 also may receive web pages generated in response to user requests from browsers executing on computing devices 350. The computing system 300 is further capable of receiving VPN communications and passes those to the VPN system in the illustrated embodiment.

The communications are received by the computing system 300 in the form of digital packets. A packet may constitute a complete communication or may need to be combined at the destination with other packets to create a complete communication, such as an email message or web page. Each packet includes various packet identification information such as the source of the packet (usually an IP address), the destination of the packet, authentication information, and other information in addition to the payload of data that contains the actual message of the communication.

The computing system 300 includes an integrated monitoring function that screens the packets as they are received and can automatically block packets from sources that the integrated monitoring function that determines from the screening to be likely sources of potential threats to the computer network. The integrated monitoring function includes an SSI 312, including an event database 310 as described with reference to FIG. 2, and a plurality of monitoring functions.

The integrated monitoring function 302 screens all incoming communications using a set of rules, referred to as intrusion detection (“ID”) rules, to screen each packet as it is received from the communications network. The integrated monitoring function 302 maintains the ID rules in a database or in one or files (not shown) and is capable of deleting rules and receiving new or changed rules as directed by a system administrator or by the SSI 312.

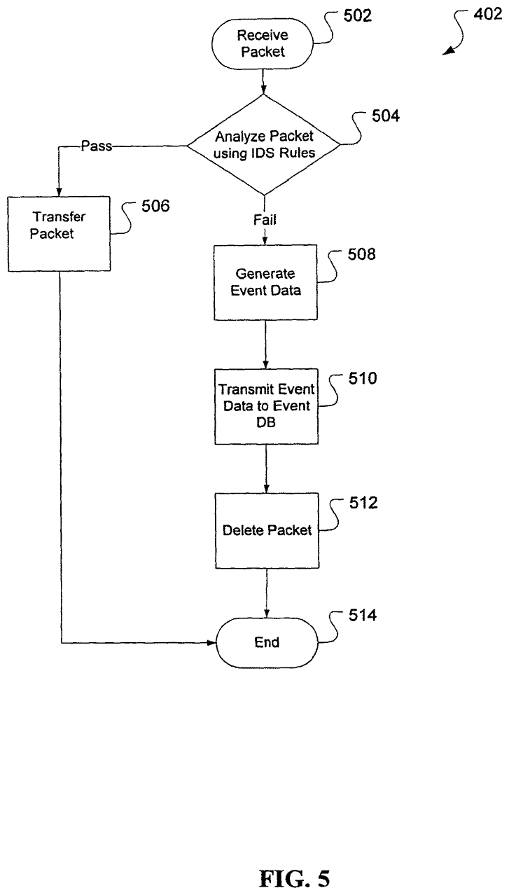

Upon receipt of a packet from the communication network 330, the integrated monitoring function compares the information in the packet with the current ID screening and blocking rules and either deletes the packet or passes it on to the firewall as will be described in greater detail with reference to FIG. 5. In addition, whenever the integrated monitoring function 302 deletes a packet (i.e., a packet fails one of the ID rules), the integrated monitoring function 302 generates event data, which are transmitted to the event data database 310.

In the embodiment shown, the integrated monitoring function also implements the blocking of incoming communications based on the source of the communications. Thus, the integrated monitoring function can be considered, and indeed is often implemented, as two functions: a screening or monitoring functioning and a blocking function. For the balance of this specification, no differentiation will be made between the two functions within the integrated monitoring function 302.

However, one skilled in the art will understand that the integrated monitoring function 302 could be similarly implemented as two independent functions. Furthermore, the term ID rules in this specification refers generally to rules that block incoming packets based on their source as these rules, in this embodiment, would be implemented by the blocking component of the integrated monitoring function. As such, integrated monitoring function rules are distinct from the screening criteria used by the integrated monitoring function, as well as the other functions' screening criteria in this embodiment.

This event data is transmitted to the event database in the SSI 312.

The chipset stores the web page packets to screen the web pages for inappropriate content based on web content rules provided by the administrator or end user. Such screening may require receiving all the packets that make up a webpage before the screening may be performed. Alternatively, some screening may be performed on individual packets as they arrive, while other screening is performed after receipt of the complete web page element.

The web content rules may be stored in a separate file or database and maintained by the administrator. If a web page passes the screening, the web page is transmitted to its destination computing device 350. If a web page fails the screening, it may be deleted, and a substitute page may be sent in its stead.

The event data is transmitted to the SSI 312 for analysis and storage in the event database 310.

The computing system 300 includes a network directory service 342 that is used to authenticate destinations and users known to the system. A different network directory service 342 may be provided for each type of destination and packet or a single integrated network directory service 342 may be used.

The computing system 300 may be part of a multi-system implementation as described in U.S. application Ser. No. 10/768,931, filed Jan. 29, 2004. In the multi-system implementation, the computing system 300 is in communication with a remote computing system (not shown), either via the communications network 330 or a dedicated connection (not shown), that maintains a security system master integrated (“SSMI”).

The computing system 300 transmits some or all of the event data stored in the event database 310 to the SSMI for analysis. The SSMI, which also collects event data from other computing systems at other sites, analyzes the collected set of event data. The SSMI may perform the some or all of the analyses described below with reference to the SSI 312 and may perform additional analyses on the collected multi-system event data and generate and return rules to the SSI 312 for implementation by the computing system 300.

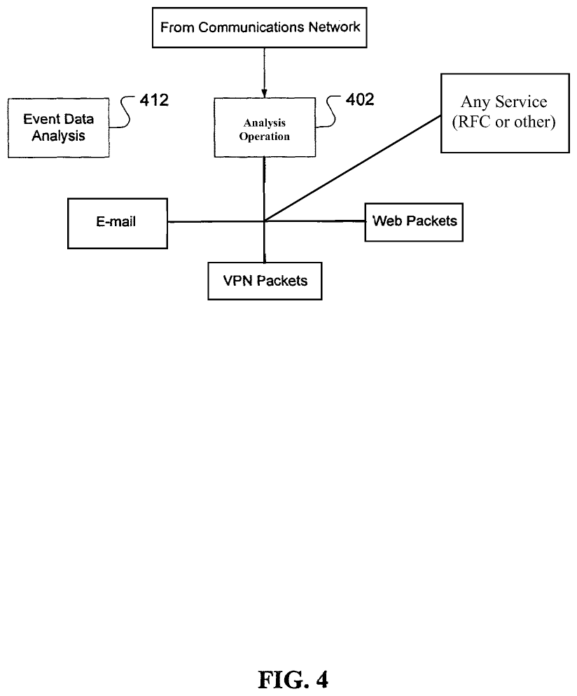

FIG. 4 illustrates the main logical operations of the chipset performed before a communication packet is transferred into the protected network 352. The first operation performed on communication packets received by the monitoring functioning system is an analysis operation 402, which is discussed in greater detail with reference to FIG. 5. A blocking analysis may result in blocking the incoming packet. In addition, a screening analysis may or may not result in the generation of event data.

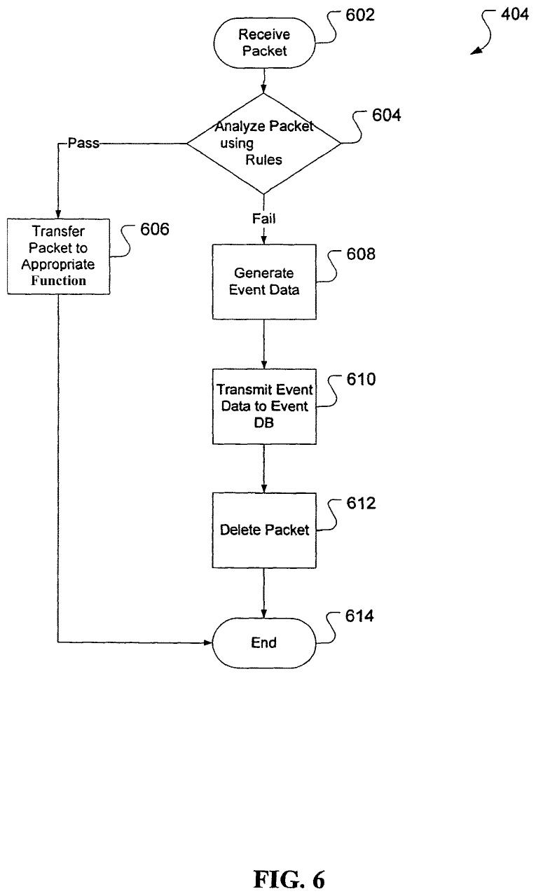

If a communication packet passes the analysis operation 402, an analysis operation is performed on the communication packet. The communication analysis operation is discussed with greater detail with reference to FIG. 6.

A communications packet that passes the analysis operation 404 is then transferred to an appropriate analysis based on the type of the communication packet (i.e., e-mail, VPN, web page or other service packets). Web page packets are put through a web content analysis operation. VPN packets are transferred to a VPN analysis operation. A packet that passes its appropriate analysis based on its type is then allowed to enter the protected network 352 for delivery to its destination.

The analysis operations 402 described above are referred to as packet analysis operations because they analyze communication packets against some pre-determined criteria. In addition, as will be described in greater detail below, the packet analysis operations 402 also generate event data for packets that fail an analysis.

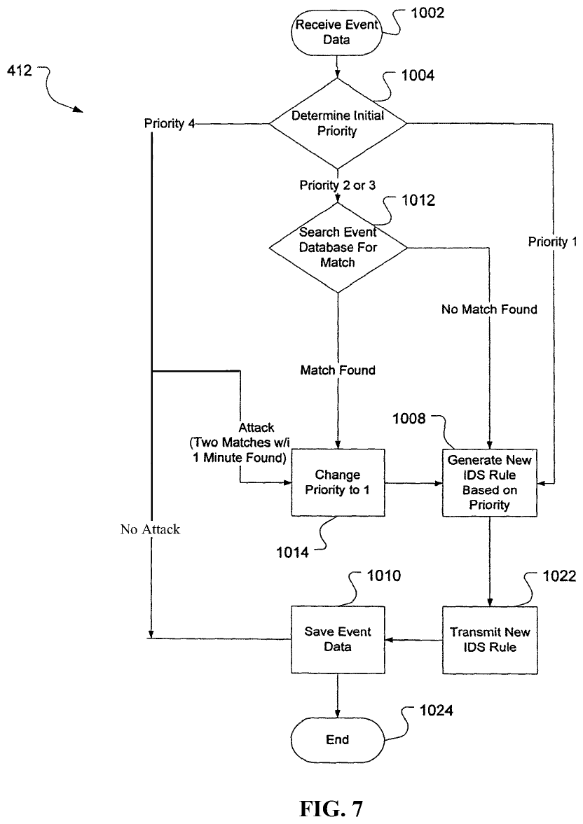

The ASIC chipset also analyzes the event data in an event data analysis operation 412. The event data analysis operation 412 automatically generates new or revised criteria for use by one or more of the packet analysis operations based on the event data received and an event data rule set. The event data analysis operation 412 is discussed in greater detail with reference to FIG. 7.

One skilled in the art will recognize that the scope of the invention is not limited to that specific embodiment and that other embodiments of computing systems for monitoring any combination different types of digitized communication data are contemplated.

FIG. 5 illustrates the logical operations of the analysis operation 402. In an embodiment, packets are received from the communication network. The analysis operation 402 starts when a communication packet is read from the input buffer by the integrated monitoring function 302 in a receive packet operation 502.

A packet read from the input buffer is then analyzed in a rules analysis operation 504. The rules analysis operation 504 determines if there are any rules that indicate that the communication packet should be barred from entering the protected network 352 based on the information available in the packet. The rules analysis operation 504 includes retrieving or otherwise accessing a pre-determined set of blocking and screening rules. The rules may be maintained in memory in the or may be stored in a remote database and may need to be retrieved as part of the rules analysis operation 504.

The rules analysis operation 504 compares the information in the communication packet against the rules of the rules set. This may include reading some or all of the information from the communication packet such as date and time the packet was received, the source of the packet, the destination of the packet, and the payload of the packet. Information may be read from the packet automatically or may be read in response to a specific rule.

Screening rules are generally known in the art and include rules that determine if the packet is of a known type or not, if the packet is part of a request for information from within the protected network, if the packet is part of a login request, if the packet is part of a remote procedure call, if the packet is directed at an unusual port, if the packet is an administrative access request, and if the packet is requesting access to a potentially vulnerable web application.

A communication packet “passes” the rule analysis operation 504 if there are no rules that indicate that the communication packet should be barred from entering the protected network 352. A communication packet that passes the rule analysis is transferred in a transfer packet as shown at 506.

However, if the set of rules contains at least one rule that indicates that the communication packet should be prevented from entering the protected network, the packet “fails” the rules analysis operation 504. Upon determination that a packet has failed the rules analysis operation, a generate event data operation 508 is performed. The generate event data operation 508 includes collecting certain information from the failed packet. This information includes at least the source of the packet and may include some or all of the event data described in Table 1 that is directly available from the packet. The event data may also identify the rule or rules that the packet failed and may identify what failed the packet.

In the illustrated embodiment, the generate event data operation 508 also includes assigning a priority to the failed packet. A priority is a numerical identifier that indicates the presumed relative threat of the packet to the protected network. In one embodiment, there are three priorities, or priority levels, ranging from a highest priority (priority level “1”) to a lowest priority for failing packets (“3”) with there being one intermediate priority (“2”).

In general, a priority 1 event is a packet that, in whole or in part, is an actual attack on the protected network, a priority 2 event is an attempt to break into (intrude) the protected network, and a priority 3 event is a reconnaissance or probing of the protected network. In alternative embodiments, fewer or more priority levels may be used to differentiate different threats or perceived threats.

The priority assigned may be dictated by the rule that the packet failed. If the packet fails more than one rule, the packet may be assigned the highest priority regardless of the priorities that would be assigned by the failing rules. Alternatively, the packet may be assigned the highest priority directed by the failing rules (e.g., if a packet fails two rules, one that assigns failing packets as priority 3 events and one that assigns failing packets as priority 2 events, the packet is assigned a priority of 2).

Other methods of assigning a priority to a packet are also contemplated. For example, the priority assigned may be dictated by the number of rules that the packet failed. In another embodiment, a priority is assigned that indicates that the packet failed or indicates which rule or group of rules failed the packet.

After the event data is generated, an event data message is created and transmitted to the SSI 312 in a transmit event data operation 510.

Failure of a packet by the rule analysis operation 504 also results in a delete packet operation 512. This operation 512 deletes the packet from the computer system 300, thereby preventing the packet from reaching its destination and freeing up resources for analysis of later received packets. In an embodiment, deleting the packet may include saving a copy of the packet to a deleted packet database for further analysis. One skilled in the art will recognize that the exact order of the operations described above with respect to the analysis may be varied and that the deleted packet operation 512 could be performed before the transmit event data operation 510.

Upon completion of the above-described analysis operations, the analysis operational flow ends in an end operation 514 and the functionality either reads the next packet from the input buffer or goes into a standby mode waiting for the next communication packet to be received by the buffer.

FIG. 6 illustrates an embodiment of the logical operations of a chipset analysis operation 404. The flow starts when a packet is received in a receive packet operation 602.

After receipt of a packet passed by the analysis operation, a chipset rule analysis operation 604 is performed. The chipset rule analysis operation 604 determines if there are any chipset rules that indicate that the communication packet should be barred from entering the protected network 352 based on the information available in the packet. The chipset rules analysis operation 604 includes retrieving or otherwise accessing a pre-determined set of chipset rules. The chipset rules may be maintained in memory in the chipset or may be stored in a remote database and may need to be retrieved as part of the chipset rules analysis operation 604.

The chipset rules analysis operation 604 compares the information in the communication packet against the rules of the chipset rules set. This may include reading some or all of the information from the communication packet such as date and time the packet was received, the source of the packet, the destination of the packet, and the payload of the packet. Information may be read from the packet automatically or may be read in response to a specific chipset rule.

The chipset rules analysis operation 604 also identifies the type (i.e., in this embodiment e-mail, VPN, or web page) of the communication packet received.

A communication packet “passes” the chipset rule analysis operation 604 if there are no chipset rules that indicate that the communication packet should be barred from entering the protected network 352 and the packet's type can be identified. Thus, a packet that passes all the other chipset rules but for which a type cannot be identified fail the chipset rule analysis operation 604.

A communication packet that passes the chipset rules analysis is transferred to the appropriate based on its type in a transfer to next operation 606 and the operational flow ends 614 as discussed below.

A packet “fails” the chipset rules analysis operation 604 if the set of chipset rules contains at least one rule that indicates that the communication packet should be prevented from entering the protected network. A packet also fails the chipset rules analysis operation 604 if its type cannot be identified by the chipset.

Upon determination that a packet has failed the chipset rules analysis operation 604, a generate event data operation 608 is performed. The generate event data operation 608 includes collecting certain information from the failed packet. This information includes at least the source of the packet and may include some or all of the event data described in Table 1 that is directly available from the packet. The event data may also identify the chipset rule or rules that the packet failed and may identify the chipset as the that failed the packet.

The generate event data operation 608 may also include assigning a priority to the packet. The priority may be dictated based on the chipset rule or rules that the packet failed. Alternatively, all packets failing the chipset may be assigned the same priority. For example, in an embodiment of the invention all packets failing the chipset rules analysis operation 604 are assigned the intermediate priority of 2.

After the event data is generated, an event data message is created and transmitted to the SSI 312 in a transmit event data operation 610. If a priority was assigned in the generate event data operation 608, then the priority may be included with the other event data in the event data message.

Failure of a packet by the chipset rules analysis operation 604 also results in a delete packet operation 612. The delete operation 612 deletes the packet from the computer system 300, thereby preventing the packet from reaching its destination and freeing up resources for analysis of later received packets.

In an embodiment, deleting the packet may include saving a copy of the packet to a deleted packet database for further analysis. One skilled in the art will recognize that the exact order of the operations described above with respect to the chipset analysis is exemplary only and that the operations may be reordered or modified without changing the fundamental function of the chipset analysis operation 404.

Upon completion of the chipset analysis operation 404, the operational flow ends 614 and the chipset either reads the next packet received or goes into a standby mode waiting for the next communication packet to be received from the analysis operation.

FIG. 7 illustrates the logical operations of the event data analysis operation 412. The operational flow starts when an event data message containing event data is received from a monitoring function in a receive event data operation 1002.

After receipt of the event data message, an initial priority operation 1004 is performed to determine the event data includes an assigned priority. If the event data in the message includes a priority assigned by the monitoring function that transmitted the event data, then the initial priority of the event is the assigned priority. If there is no assigned priority, then the initial priority operation 1004 assigns an initial priority to the event data. The assignment is made based on the information in the event data such as the monitoring function generating the event data, the reason for failure of the packet, or the type of packet.

For example, in an embodiment of the initial priority operation 1004 all packets failed by the monitoring function are assigned an initial priority of 2 and packets failed by the analysis operation are assigned an initial priority of 1, 2 or 3 depending on the rule or rules that the packet failed. The rule or rules may be identified in the event data or the rules analysis operation 504 may be repeated on the event data by the SSI 312 to identify the rule or rules as part of the assignment. In the embodiment, all packets failed by the attack detection monitoring function or VPN monitoring function are assigned an initial priority of 4.

If the initial priority operation 1004 determines that the event data has a priority of 1, then a generate rule operation 1008 is performed in which a priority 1 rule is generated and transmitted to the analysis operation for addition to the set of rules maintained by the analysis operation. The generate rule operation 1008 is discussed in greater detail below.

However, if the if the initial priority operation 1004 determines that the event data has an initial priority of 2 or 3, a search operation 1012 searches the event database for an event record identifying the same packet source as that identified in the event data received in the receive event data operation 1002. If an event record is found with the same packet source, then an upgrade priority operation 1014 changes the priority of the event data to priority 1 and control transfers to the generate priority 1 rule operation 1008 previously discussed. However, if the search operation 1012 does not find an event record with the same source as that of the identified in the event data received in the receive event data operation 1002, then control transfers to the generate rule operation 1008 discussed below.

An embodiment of the search operation 1012 may also include performing a Bayesian analysis on the results of the search to verify that an upgrade in priority is warranted given the level of security desired by the administrator of the computing system 300. Such an analysis may be focused on reducing the number of false positives or increasing the relative percentage of true positives depending on the security preferences.

If the initial priority operation 1004 determines that event data does not have an initial priority of 1, 2 or 3, then an attack event operation determines if the event data message received in receive operation 1002 was generated by the attack detection monitoring function. If the event data message was not generated by the attack detection monitoring function, then control transfers to the save event data operation 1010.

If the event data message was generated by the attack detection monitoring function, then an attack detection operation is performed. The attack detection operation searches the event database event records indicating infected e-mails were previously received from the same source as the event data received in receive operation 1002. In an embodiment, an attack is presumed if a predetermined number of e-mails from the same source failed the attack detection monitoring function within a predetermined period of time.

The number of e-mails and period used may be predetermined by the administrator of the computing system 300. In an embodiment, an attack is presumed if three or more virus-containing e-mails are received from the same source within a one-minute period. The SSI 312 makes the attack determination by searching the event database for records indicating receipt of the predetermined number of virus-containing e-mails within the period. If the attack detection operation finds that the attack criteria is not met, then operation flow transfers to the save event data operation 1010.

However, if the attack detection operation determines that the attack criteria are met, the priority of the event data is upgraded to a priority of 3 in a priority level 3 upgrade operation 1020. After the priority is upgraded to 3, the operation flow is transferred to the search operation 1012 described above.

Turning now to the generate rule operation 1008, the generate rule operation 1008 generates a rule for use by one or more monitoring function in the computer system 300. For simplicity, the generate rule operation 1008 will be described in terms of generating a rule that will be used by the analysis operation in subsequent analyses 402. However, the generate rule operation 1008 may also generate rules specifically for use by any of the other monitoring function. Such rule generation could be based on the type of communication or on any rule consistent with the final priority assigned by the SSI 312 to the event data received in an event data message. Thus, if the event data received is assigned a priority of 1, then the generate rule operation 1008 generates a priority 1 rule. Similarly, if the event data received is assigned a priority of 2, then the generate rule operation 1008 generates a priority 2 rule and if the event data received is assigned a priority of 3, then the generate rule operation 1008 generates a priority 3 rule. A priority 1 rule is a rule that causes the analysis operation to delete all packets received from the source identified in the event data for some predetermined blocking period, such as 24 hours, from the receipt of the packet that caused the event data to be generated. A priority 2 rule is a rule that causes the analysis operation to delete all packets received from the source identified in the event data for some predetermined blocking period less than that of the priority 1 rule, such as 4 hours, from the receipt of the packet generating the event data.

A priority 3 rule is a rule that causes the analysis operation to delete all packets received from the packet source identified in the event data for some predetermined period less than that of the priority 2 rule, such as 1 hour, from the receipt of the packet generating the event data. The rule generated may identify the source, such as the source IP address, and an expiration date and time for the rule calculated based on the appropriate blocking period.

The rule generated by the generate rule operation 1008 is added to the rule database by a transmit new rule operation 1022. The transmit new rule operation 1022 may entail writing the new rule directly to the rule database or, if the rule database is maintained by the administrator, may include transmitting the generated rule to the analysis operation for addition to the rule database.

Regardless of the implementation, the new rule is ultimately added to the set of rules used by the analysis operation in the rules analysis operation 504. Thus, based on the automated analysis of event data received from the monitoring function, the new rules are generated for the analysis operation in real time as packets are received and evaluated by the monitoring function. Upon completion of the transmit rule operation 1022, a save event data operation 1010 is performed that saves the event data received in the receive event data operation 1002 into a new event record. Some or all of the event data provided in the event data message may be saved in the new record.

In addition, the final priority assigned to the event data is also saved in the event record. The save event data operation 1010 may also cause to be saved a log of the actions taken by the SSI 312 in response to receipt of the event data, such as a log identifying the generation of a rule and transmission of a notification message in response to a rule generation.

Upon completion of the save event data operation 1010, the operational flow ends in an end operation 1024 which causes the SSI 312 to either repeat the event data analysis operation 412 on the next event data message pending analysis or enter a standby mode until the next event data message is received. In a multi-system implementation, the save event data operation 1010 may include transmitting the event data with its site-generated priority to the SSMI for additional analysis with the benefit of the event data received from other computing systems.

The operational flow described with reference to FIG. 7 is one embodiment of an event data analysis operation 412 that receives event data from a plurality of monitoring functions and, based on an analysis of the event data in real time, automatically generates one or more rules for the monitoring functions. Although the embodiment in FIG. 7 only generated rules for the analysis operation, the scope of application is not limited. Alternative embodiments are possible and contemplated that generate rules for the other monitoring functions and also for monitoring functions that are not described in FIG. 3.

Turning now to a particular example of the operational flow of FIG. 7, consider event data received from a web monitoring function that failed a web page element being retrieved by a computing device in the protected network. In an embodiment, all web page content failure events are assigned a priority of 2 by the web monitoring function. The event data would be received by the SSI 312 in the received event data operation 1002. The initial priority operation 1004 would identify the event data as having an event priority of 2 and the search operation 1012 would search the database 310 for any other event records from the same IP address as the failed web page element.

For the purposes of discussion, assume that the search 1012 found at least one other event record in the event database 310 indicates the source of the failing communication was the same IP address as the failed web page element. The upgrade priority operation 1014 changes the priority of the event data to a priority of 1 and a priority 1 rule is generated in the generate rule operation 1008. The transmit rule operation 1022 then transmits the new rule to the blocking rule database.

In the embodiment, this is achieved by either revising an expiration time of an existing rule that blocks the web page element's source to 24 hours from the web page element's receipt or by adding a new rule to the rule database that blocks packets from the web page element's source for 24 hours from the time of receipt of the web page element. The event data including the newly assigned priority of 1 are then saved in the save event data operation 1010 and the SSI's 312 processing of that event ends.

Various embodiments of the invention have been described in detail with reference to the drawings, wherein like reference numerals represent like parts and assemblies throughout the several views. Reference to various embodiments does not limit the scope of the invention, which is limited only by the scope of the claims attached hereto. Those skilled in the art will readily recognize various modifications and changes that may be made to the invention without following the example embodiments and applications illustrated and described herein, and without departing from the true spirit and scope of the invention, which is set forth in the following claims. Additionally, any examples set forth in this specification are not intended to be limiting and merely set forth some of the many possible embodiments for the claimed invention.

1. A cyber-safety threat detection system for proactively detecting an intrusion attempt of a computing device, wherein the computing device is configured to receive communication data packets from an external communication network, wherein when moving from the external communication network to the computing device, the communication data packets pass through the cyber-safety threat detection system, wherein the cyber-safety threat detection system is provided on an application specific integrated circuit (“ASIC”) chipset or a system on a chip (“SOC”) and wherein the cyber-safety threat detection system comprises:
a threat event database;
a plurality of cyber-safety threat monitors, wherein each threat monitor is in communication with the threat event database and is configured to:
analyze the communication data packets from the external communication network and identify the communication packets that pose a security threat to the computing device by applying a plurality of security rules;
generate a threat event data for each of the communication packets that were found to pose the security threat to the computing device; and
transmit the threat event data for the security threat to the threat event database; and
a security system integrator configured to analyze the threat event data and the plurality of threat event records and, based on the results of the analysis, automatically generate at least one new security rule and add the at least one new security rule to the plurality of security rules before a subsequent communication data packet is analyzed by the plurality of monitors.

2. The cyber-safety threat detection system of claim 1, wherein the ASIC chipset or the SOC is in the computing device.

3. The cyber-safety threat detection system of claim 1, wherein operation of the cyber-safety threat detection system is agnostic to an operating system and other software on the computing device.

4. The cyber-safety threat detection system of claim 1, wherein operation of the cyber-safety threat detection system is done without calling back to a threat event database that is external to the ASIC chipset or SOC.

5. The cyber-safety threat detection system of claim 1, wherein the cyber-safety threat detection system is capable of detecting threats in 2-4 microseconds.

6. The cyber-safety threat detection system of claim 1, wherein the threat event data includes a source IP address of the communication data packets that were found to pose the security threat to the computing device and wherein each of the plurality of monitors is configured to their respective threat event data in the threat event records of the threat event database.

7. The cyber-safety threat detection system of claim 1, wherein each of the plurality of monitors independently performs the analysis of the communication data packets from the external communication network.

8. The cyber-safety threat detection system of claim 1, wherein the threat event database is configured to store the threat event records for the threat event data received from the plurality of monitors in a common database associated with each of the plurality of monitors and wherein the threat event database is continuously and dynamically updatable.

9. A cyber-safety threat detection method for proactively detecting an intrusion attempt of a computing device, wherein the method comprises:
transmitting communication data packets from an external communication network to a computing device, wherein when moving from the external communication network to the computing device, the communication data packets pass through a cyber-safety threat detection system provided on an application specific integrated circuit (“ASIC”) chipset or a system on a chip (“SOC”), wherein the cyber-safety threat detection system comprises a threat event database, a plurality of cyber-safety threat monitors and a security system integrator and wherein the threat monitors:
communicate with the threat event database;
analyze the communication data packets;
identify the communication packets that pose a security threat to the computing device by applying a plurality of security rules;
generate a threat event data for each of the communication packets that were found to pose the security threat to the computing device; and
transmit the threat event data for the security threat to the threat event database;
analyzing the threat event data and the plurality of threat event records using the security system integrator and, based on the results of the analysis, automatically generating at least one new security rule; and
adding the at least one new security rule to the plurality of security rules before a subsequent communication data packet is analyzed by the plurality of monitors.

10. The cyber-safety threat detection method of claim 9, wherein the threat event database is continuously and dynamically updatable.

11. The cyber-safety threat detection method of claim 9, wherein the ASIC chipset or the SOC is in the computing device.

12. The cyber-safety threat detection method of claim 9, wherein operation of the cyber-safety threat detection system is agnostic to an operating system and other software on the computing device.

13. The cyber-safety threat detection method of claim 9, wherein operation of the cyber-safety threat detection system is done without calling back to a threat event database that is external to the ASIC chipset or SOC.

14. The cyber-safety threat detection method of claim 9, wherein the cyber-safety threat detection system is capable of identifying the threat in 2-4 microseconds.

15. The cyber-safety threat detection method of claim 9, wherein the threat event data includes a source IP address of the communication data packets that were found to pose the security threat to the computing device.

16. The cyber-safety threat detection method of claim 9, wherein each of the plurality of monitors independently performs the analysis of the communication data packets from the external communication network.

17. The cyber-safety threat detection method of claim 9, wherein the threat event database stores the threat event records for the threat event data received from the plurality of monitors in a common database associated with each of the plurality of monitors.

18. A cyber-safety threat detection system for proactively detecting an intrusion attempt of a computing device, wherein the computing device is configured to receive communication data packets from an external communication network, wherein when moving from the external communication network to the computing device, the communication data packets pass through the cyber-safety threat detection system, wherein the cyber-safety threat detection system is provided on an application specific integrated circuit (“ASIC”) chipset or a system on a chip (“SOC”) that is in the computing device and wherein the cyber-safety threat detection system comprises:
a threat event database;
a plurality of cyber-safety threat monitors, wherein each threat monitor is in communication with the threat event database and is configured to:
analyze the communication data packets from the external communication network and identify the communication packets that pose a security threat to the computing device by applying a plurality of security rules;
generate a threat event data for each of the communication packets that were found to pose the security threat to the computing device; and
transmit the threat event data for the security threat to the threat event database, wherein operation of the cyber-safety threat detection system is done without calling back to a threat event database that is external to the ASIC chipset or SOC; and
a security system integrator configured to analyze the threat event data and the plurality of threat event records and, based on the results of the analysis, automatically generate at least one new security rule and add the at least one new security rule to the plurality of security rules before a subsequent communication data packet is analyzed by the plurality of monitors.

19. The cyber-safety threat detection system of claim 18, wherein operation of the cyber-safety threat detection system is agnostic to an operating system and other software on the computing device.

20. The cyber-safety threat detection system of claim 18, wherein the cyber-safety threat detection system is capable of detecting threats in 2-4 microseconds.
